(19) United States
(12) Patent Application Publication
(10) Pub. No.: US 2024/0314834 A1
(43) Pub. Date: Sep. 19, 2024

(54) CHANNEL ACCESS PROCEDURES FOR MULTIPLE SL TRANSMISSIONS

(71) Applicant: Samsung Electronics Co., Ltd., Suwon-si (KR)

(72) Inventor: Hongbo Si, Allen, TX (US)

(21) Appl. No.: 18/592,228

(22) Filed: Feb. 29, 2024

Related U.S. Application Data
(60) Provisional application No. 63/452,619, filed on Mar. 16, 2023.
(60) Provisional application No. 63/452,922, filed on Mar. 17, 2023.
(60) Provisional application No. 63/525,317, filed on Jul. 6, 2023.

(51) Int. Cl. H04W 74/08; H04W 74/00; H04W 88/04

(52) U.S. Cl. CPC H04W 74/08; H04W 74/002; H04W 88/04

(57) ABSTRACT

Methods and apparatuses for channel access procedures for multiple sidelink (SL) transmissions. A method of a user equipment (UE) in a wireless communication system is includes determining to perform a first SL transmission and a second SL transmission over a channel, determining a first channel access procedure for the first SL transmission, and performing the first channel access procedure. The first SL transmission and the second SL transmission are contiguous. The method further includes determining a second channel access procedure for the second SL transmission when the first channel access procedure is unsuccessful, performing the second channel access procedure, and performing the second SL transmission when the second channel access procedure is successful.

### CROSS-REFERENCE TO RELATED APPLICATION AND CLAIM OF PRIORITY

This application claims priority under 35 U.S.C. § 119(e) to U.S. Provisional Patent Application No. 63/452,619 filed on Mar. 16, 2023, U.S. Provisional Patent Application No. 63/452,922 filed on Mar. 17, 2023, and U.S. Provisional Patent Application No. 63/525,317 filed on Jul. 6, 2023. The above-identified provisional patent applications are hereby incorporated by reference in their entirety.

### TECHNICAL FIELD

The present disclosure relates generally to wireless communication systems and, more specifically, relates to methods and apparatuses for channel access procedures for multiple sidelink (SL) transmissions.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure relates to channel access procedures for multiple SL transmissions.

In an embodiment, a user equipment (UE) in a wireless communication system is provided. The UE includes a processor configured to determine to perform a first SL transmission and a second SL transmission over a channel, determine a first channel access procedure for the first SL transmission, perform the first channel access procedure, determine a second channel access procedure for the second SL transmission when the first channel access procedure is unsuccessful, and perform the second channel access procedure. The first SL transmission and the second SL transmission are contiguous. The UE further includes a transceiver operably coupled to the processor. The transceiver is configured to perform the second SL transmission when the second channel access procedure is successful.

In another embodiment, a method of a UE in a wireless communication system is provided. The method includes determining to perform a first SL transmission and a second SL transmission over a channel, determining a first channel access procedure for the first SL transmission, and performing the first channel access procedure. The first SL transmission and the second SL transmission are contiguous. The method further includes determining a second channel access procedure for the second SL transmission when the first channel access procedure is unsuccessful, performing the second channel access procedure, and performing the second SL transmission when the second channel access procedure is successful.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example base station according to embodiments of the present disclosure;

FIG. 3 illustrates an example user equipment (UE) according to embodiments of the present disclosure;

FIGS. 4A-B illustrate example wireless transmit and receive paths according to embodiments of the present disclosure;

FIG. 5 illustrates a diagram of a channel access procedure for deferred SL transmissions according to embodiments of the present disclosure;

FIG. 6 illustrates a diagram of a channel access procedure for two starting symbols in a slot according to embodiments of the present disclosure;

FIG. 7 illustrates a diagram of channel sensing for multiples transmission occasions according to embodiments of the present disclosure;

FIG. 8 illustrates a diagram of SL transmission bursts according to embodiments of the present disclosure;

FIG. 9 illustrates a diagram of contiguous SL transmissions according to embodiments of the present disclosure;

FIG. 10 illustrates a diagram of non-contiguous SL transmissions according to embodiments of the present disclosure;

FIG. 11 illustrates a diagram continuous SL transmissions with a pause according to embodiments of the present disclosure; and

FIG. 12 illustrates a flowchart of an example UE procedure according to embodiments of the present disclosure.

### DETAILED DESCRIPTION

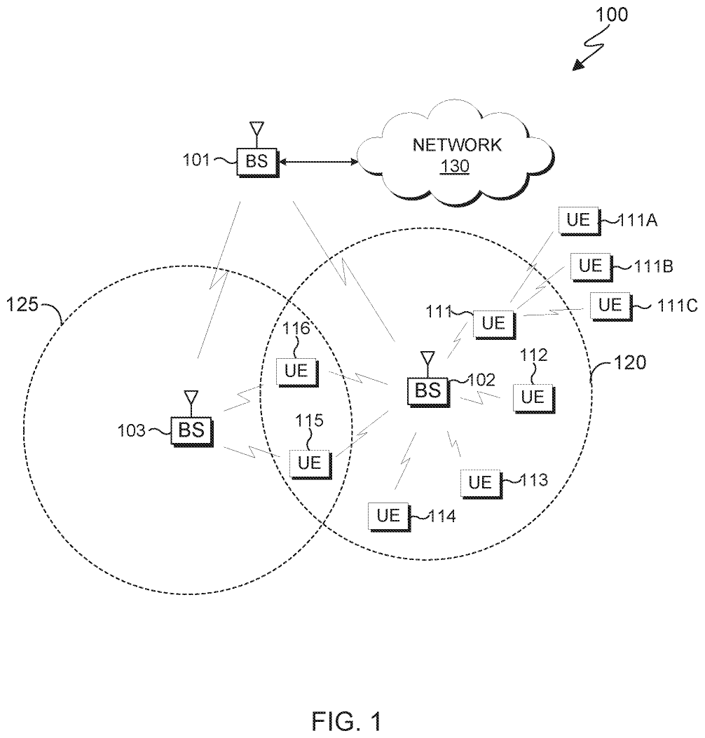

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

The following documents and standards descriptions are hereby incorporated by reference into the present disclosure as if fully set forth herein: 3GPP TS 38.211 v17.1.0, “NR; Physical channels and modulation” (REF1); 3GPP TS 38.212 v17.1.0, “NR; Multiplexing and Channel coding” (REF2); 3GPP TS 38.213 v17.1.0, “NR; Physical Layer Procedures for Control” (REF3); 3GPP TS 38.214 v17.1.0, “NR; Physical Layer Procedures for Data” (REF4); 3GPP TS 38.331 v17.1.0, “NR; Radio Resource Control (RRC) Protocol Specification” (REF5).

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

Depending on the network type, the term “base station” or “BS” can refer to any component (or collection of components) configured to provide wireless access to a network, such as base transceiver station, a radio base station, transmit point (TP), transmit-receive point (TRP), a ground gateway, an airborne gNB, a satellite system, mobile base station, an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone, smartphone, monitoring device, alarm device, fleet management device, asset tracking device, automobile, etc.) or is normally considered a stationary device (such as a desktop computer, entertainment device, infotainment device, vending machine, electricity meter, water meter, gas meter, security device, sensor device, appliance, etc.).

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

In another example, the UE 116 may be within network coverage and the other UE may be outside network coverage (e.g., UEs 111A-111C). In yet another example, both UEs are outside network coverage. In some embodiments, one or more of the gNBs 101-103 may communicate with each other and with the UEs 111-116 using 5G/NR, LTE, LTE-A, WiMAX, WiFi, or other wireless communication techniques. In some embodiments, the UEs 111-116 may use a device to device (D2D) interface called PC5 (e.g., also known as SL at the physical layer) for communication.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of gNB 101, gNB 102 and gNB 103 may support channel access procedures for multiple SL transmissions as described in embodiments of the present disclosure. In some embodiments, one or more of UEs 111-116 may perform channel access procedures for multiple SL transmissions as described in embodiments of the present disclosure.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

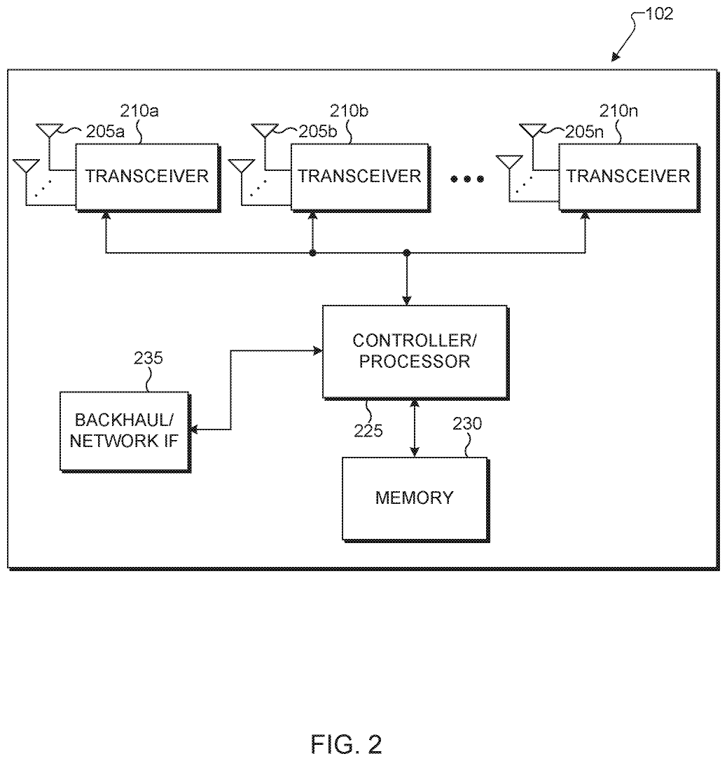

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for channel access procedures for multiple SL transmissions. Any of a wide variety of other functions could be supported in the gNB 102 by the controller/processor 225.

The controller/processor 225 is also capable of executing programs and other processes resident in the memory 230, such as processes to support channel access procedures for multiple SL transmissions. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

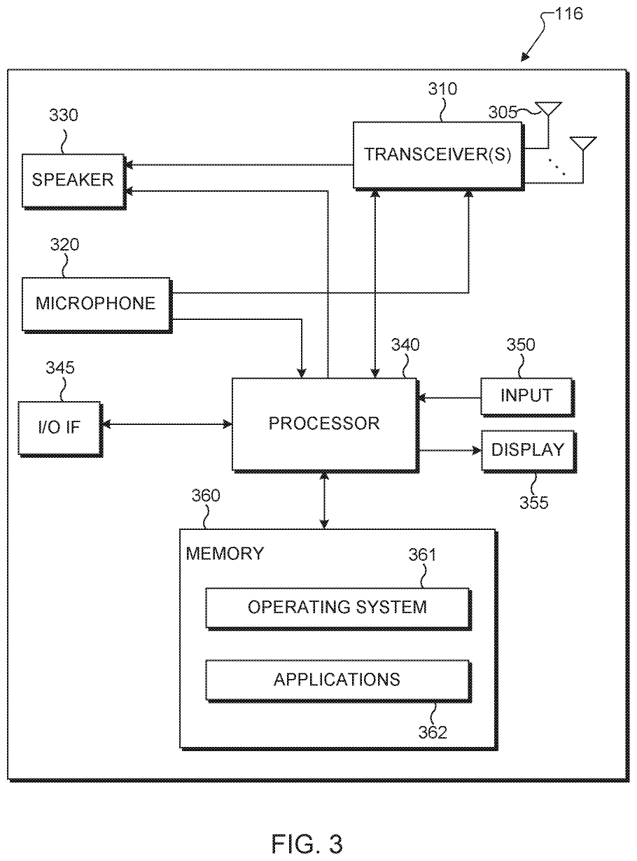

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL or SL channels or signals and the transmission of UL or SL channels or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for performing channel access procedures for multiple SL transmissions as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

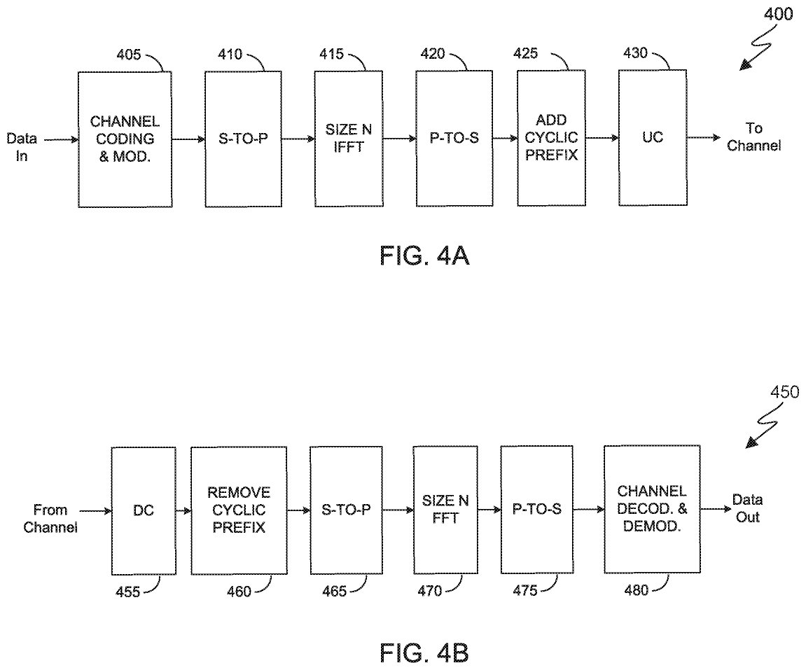

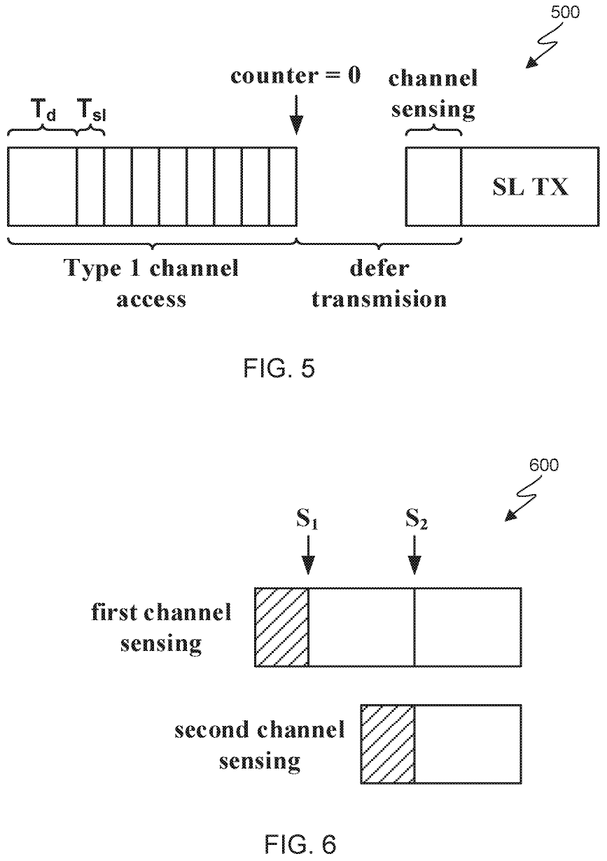

FIG. 4 and FIG. 5 illustrate example wireless transmit and receive paths 400 and 500 according to embodiments of the present disclosure. In the following description, a transmit path 400, of FIG. 4, may be described as being implemented in a gNB (such as the gNB 102) (or another UE), while a receive path 500, of FIG. 5, may be described as being implemented in a UE (such as a UE 116). However, it may be understood that the receive path 500 can be implemented in a gNB (or another UE) and that the transmit path 400 can be implemented in a UE. In some embodiments, the receive path 500 is configured to support channel access procedures for multiple SL transmissions as described in embodiments of the present disclosure.

As shown in FIG. 4, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. As shown in FIG. 5, the receive path 500 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As further shown in FIG. 4, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

A transmitted RF signal from the gNB 102 arrives at the UE 116 after passing through the wireless channel, and reverse operations to those at the gNB 102 are performed at the UE 116. As further shown in FIG. 5, the down-converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 that is analogous to transmitting in the downlink to UEs 111-116 and may implement a receive path 500 that is analogous to receiving in the uplink from UEs 111-116. Similarly, each of UEs 111-116 may implement a transmit path 400 for transmitting in the uplink to gNBs 101-103 (or in the SL for transmitting to another UE) and may implement a receive path 500 for receiving in the downlink from gNBs 101-103 (or in the SL for receiving from another UE).

Each of the components in FIG. 4 and FIG. 5 can be implemented using hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

For SL operating on unlicensed or shared spectrum, two types of channel access procedure can be supported, wherein one type of channel access procedure can be further classified into three sub-types.

In Type 1 SL channel access procedure, the time duration spanned by the sensing slots that are sensed to be idle before SL transmission(s) is random and based on a counter, wherein the channel access procedure is associated with a channel access priority class (CAPC, and denoted as e.g., p).

In Type 2 SL channel access procedure, the time duration spanned by the sensing slots that are sensed to be idle before SL transmission(s) is deterministic. In Type 2A SL channel access procedure, the time duration is deterministic as 25 μs. In Type 2B SL channel access procedure, the time duration is deterministic as 16 μs. In Type 2C SL channel access procedure, the time duration is deterministic as 0 μs.

In a legacy SL operation, a slot including a SL transmission may also be allocated for a SL reception, and after the counter reaches 0 in the Type 1 channel access procedure, the UE may not transmit the SL transmission in the slot but perform the SL reception. For this scenario, enhancement to Type 1 channel access procedure is needed.

Also, for a slot with two starting locations for SL transmissions, and for a transmission has multiple transmission occasions to choose from, channel access procedure should also be enhanced to incorporate such flexibility in time domain.

Meanwhile, interaction between Type 1 and Type 2 channel access procedure should also be considered, to support flexible and efficient channel access.

Additionally, in the legacy SL operation, the resource allocation and reservation can be in continuous slots or non-continuous slots, according to the resource sensing resources or indication from a gNB/UE. When the resources are in non-continuous slots, the gap between resources can be large and an extra channel access procedure could be needed to recover the channel occupancy. Even when the resources are in continuous slots, legacy SL slot format reserves at least one symbol at the end of each slot as guard symbol and the duration of such symbol can be large such that an extra channel access procedure could be needed to recover the channel occupancy. In either case, enhancement to channel access procedure is needed.

FIG. 5 illustrates a diagram 500 of a channel access procedure for deferred SL transmissions according to embodiments of this disclosure. The embodiment of the diagram 500 illustrated in FIG. 5 is for illustration only. FIG. 5 does not limit the scope of this disclosure to any particular implementation of the diagram 500. The channel access procedure illustrated by diagram 500 may be implemented by a UE, (e.g., UE 116), in a wireless network system (e.g., 100).

In one embodiment, when the counter reaches 0 in the Type 1 SL channel access procedure (e.g., denoting the timing as t₁), the UE (e.g., UE 116) may not start the SL transmission, and can start the SL transmission later (e.g., with a defer time duration, and denoted the deferred timing as t₂ where t₂>t₁) with additional channel sensing procedure(s) according to at least one of the following examples. The UE may restart the Type 1 SL channel access procedure (e.g., generate a new counter after the channel is sensed to be idle for a duration of T_{d}), if the channel is not sensed as idle in at least one of the following example channel sensing procedures (e.g., the example channel sensing procedure is not successful).

For one example, the channel can be sensed to be idle at least for a first sensing duration, when the UE is ready to transmit the transmission. For instance, the first sensing duration can be Tₛₗ (e.g., Tₛₗ=9 μs).

For another example, the channel can be sensed to be idle for all sensing slots in a second sensing duration immediately before the intended transmission. For instance, the second sensing duration can be T_{d} (e.g., T_{d}=T_{f}+mₚ·Tₛₗ, wherein T_{f}=16 μs, Tₛₗ=9 μs, and mₚ is an integer associated with CAPC p).

FIG. 6 illustrates a diagram 600 of a channel access procedure for two starting symbols in a slot according to embodiments of this disclosure. The embodiment of the diagram 600 illustrated in FIG. 6 is for illustration only. FIG. 6 does not limit the scope of this disclosure to any particular implementation of the diagram 600. The channel access procedure for two starting symbols illustrated by diagram 600 may be implemented by a UE, (e.g., UE 116), in a wireless network system (e.g., 100).

In embodiments, when a UE (e.g., UE 116) identifies two potential starting symbols (e.g., denoted as S₁ and S₂, wherein S₂>S₁) for SL transmission(s) (e.g., physical SL shared channel (PSSCH)/physical SL control channel (PSCCH) transmission) in a slot, the UE can perform a second channel access procedure before the second starting symbol in the same slot (e.g., S₂), if the first channel access procedure before the first starting symbol (e.g., S₁) fails (e.g., the UE cannot access the channel after the first channel access procedure).

For example, if the UE (e.g., UE 116) determines to use a Type 1 SL channel access procedure for the first channel access procedure (e.g., the UE initiates a channel occupancy, or the UE is indicated to use Type 1 SL channel access procedure in a sidelink control information (SCI) and/or a downlink control information (DCI)) and fails, the UE can perform another Type 1 SL channel access procedure for the second channel access procedure.

In a further example, there is no limitation on the number of attempts that the UE can make using the Type 1 SL channel access procedure.

In another example, if the UE (e.g., UE 116) determines to use a Type 2A channel access procedure for the first channel access procedure (e.g., based on an indication in a SCI and/or a DCI, or based on knowing the transmission is within a channel occupancy shared to the UE and the gap from previous transmission satisfies the condition to use Type 2A SL channel access procedure) and fails, the UE can perform another Type 2A channel access procedure for the second channel access procedure. For this example, the transmission from the second starting symbol is within the channel occupancy.

In a further example, there is no limitation on the number of attempts that the UE can make using Type 2A channel access procedure.

In another further example, there can be a limitation on the number of attempts that the UE can make using Type 2A channel access procedure.

For example, the limitation on the number can be given by x+1, wherein x is the number of consecutive slots in the intended SL transmission burst that the Type 2A channel access procedure is intended to be applied.

For example, the limitation on the number can be given by x+1, wherein x is the number of consecutive subframes or time duration in ms in the intended SL transmission burst that the Type 2A channel access procedure is intended to be applied.

For yet another example, the limitation on the number can be given by 2·x, wherein x is the number of consecutive slots in the intended SL transmission burst that the Type 2A channel access procedure is intended to be applied.

In other examples, the limitation on the number can be given by 2·x−y, wherein x is the number of consecutive slots in the intended SL transmission burst that the Type 2A channel access procedure is intended to be applied, and y is the number of slots that only includes single starting symbol in the slot.

In another example, if the UE (e.g., UE 116) determines to use a Type 2B channel access procedure for the first channel access procedure (e.g., based on an indication in a SCI and/or a DCI, or based on knowing the transmission is within a channel occupancy shared to the UE and the gap from previous transmission satisfies the condition to use Type 2B SL channel access procedure) and fails, the UE can perform a Type 2A channel access procedure for the second channel access procedure. For this example, the transmission from the second starting symbol is within the channel occupancy.

In an additional example, there is no limitation on the number of attempts that the UE can make using Type 2A channel access procedure.

In another example, there can be a limitation on the number of attempts that the UE can make using Type 2A channel access procedure.

In some examples, the limitation on the number can be given by x, wherein x is the number of consecutive slots in the intended SL transmission burst that the Type 2B channel access procedure is intended to be applied.

In more examples, the limitation on the number can be given by x, wherein x is the number of consecutive subframes or time duration in ms in the intended SL transmission burst that the Type 2B channel access procedure is intended to be applied.

For additional examples, the limitation on the number can be given by 2·x−1, wherein x is the number of consecutive slots in the intended SL transmission burst that the Type 2B channel access procedure is intended to be applied.

For yet another example, the limitation on the number can be given by 2·x−y−1, wherein x is the number of consecutive slots in the intended SL transmission burst that the Type 2B channel access procedure is intended to be applied, and y is the number of slots that only includes single starting symbol in the slot.

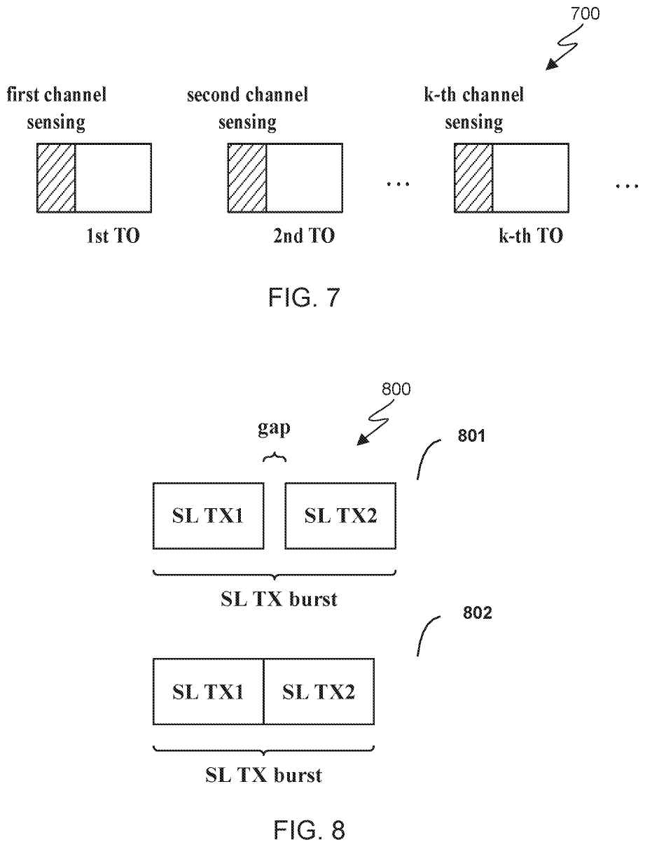

FIG. 7 illustrates a diagram 700 of channel sensing for multiple transmission occasions according to embodiments of this disclosure. The embodiment of the diagram 700 illustrated in FIG. 7 is for illustration only. FIG. 7 does not limit the scope of this disclosure to any particular implementation of the diagram 700. The channel sensing for multiple transmission procedure illustrated by diagram 700 may be implemented by a UE, (e.g., UE 116), in a wireless network system (e.g., 100).

In embodiments, when a UE (e.g., UE 116) identifies multiple transmission occasions (e.g., non-overlapping occasions in time) for an intended SL transmission, if the first channel access procedure before the first transmission occasion (TO) fails (e.g., the UE cannot access the channel after the first channel access procedure), the UE can perform additional channel access procedure before the remaining transmission occasion(s) (e.g., the k-th channel access procedure associated with the k-th TO, where k>1).

For example, the multiple transmission occasions can be the ones for the transmission of a transport block (TB) carried by PSSCH, and the k-th transmission occasion corresponds to the k-th attempt of the transmission.

For another example, the multiple transmission occasions can be the ones for the transmission of a physical SL feedback channel (PSFCH) associated with a PSSCH/PSCCH (e.g., with HARQ feedback enabled), and the k-th transmission occasion corresponds to the k-th attempt of the PSFCH transmission.

For yet another example, the multiple transmission occasions can be the ones for the transmission of a SL synchronization signal/physical SL broadcast channel (S-SS/PSBCH) block, and the k-th transmission occasion corresponds to the k-th attempt of the S-SS/PSBCH block transmission.

For one example, if the UE identifies to use Type 1 SL channel access procedure for the k-th channel access procedure (e.g., the UE initiates a channel occupancy, or the UE is indicated to use Type 1 SL channel access procedure in a SCI and/or a DCI), the UE can perform Type 1 SL channel access procedure for the (k+1)-th channel access procedure.

In some further examples, there is no limitation on the number of attempts that the UE can make using Type 1 SL channel access procedure.

For more examples, if the UE identifies to use Type 2A channel access procedure for the k-th channel access procedure (e.g., based on an indication in a SCI and/or a DCI, or based on knowing the transmission is within a channel occupancy shared to the UE and the gap from previous transmission satisfies the condition to use Type 2A SL channel access procedure), the UE can perform Type 2A channel access procedure for the (k+1)-th channel access procedure. For this example, the (k+1)-th transmission occasion is within the channel occupancy.

In one further example, there is no limitation on the number of attempts that the UE can make using Type 2A channel access procedure.

In another further example, there can be a limitation on the number of attempts that the UE can make using Type 2A channel access procedure.

For example, the limitation on the number can be given by x, wherein x is the number of consecutive slots in the intended SL transmission burst that the Type 2A channel access procedure is intended to be applied.

In another example, the limitation on the number can be given by x, wherein x is the number of consecutive subframes or time duration in ms in the intended SL transmission burst that the Type 2A channel access procedure is intended to be applied.

For yet another example, if the UE identifies to use Type 2B channel access procedure for the k-th channel access procedure (e.g., based on an indication in a SCI and/or a DCI, or based on knowing the transmission is within a channel occupancy shared to the UE and the gap from previous transmission satisfies the condition to use Type 2B SL channel access procedure), the UE can perform Type 2A channel access procedure for the (k+1)-th channel access procedure. For this example, the (k+1)-th transmission occasion is within the channel occupancy.

In some further examples, there is no limitation on the number of attempts that the UE can make using Type 2A channel access procedure.

In more examples, there can be a limitation on the number of attempts that the UE can make using Type 2A channel access procedure.

For yet another example, the limitation on the number can be given by x, wherein x is the number of consecutive slots in the intended SL transmission burst that the Type 2B channel access procedure is intended to be applied.

For example, the limitation on the number can be given by x, wherein x is the number of consecutive subframes or time duration in ms in the intended SL transmission burst that the Type 2B channel access procedure is intended to be applied.

In another embodiment, when a UE (e.g., 116) identifies multiple transmission occasions (e.g., non-overlapping occasions in time) for an intended SL transmission, if the k-th channel access procedure before the k-th transmission occasion (TO) succeeds (e.g., the UE can access the channel after the k-th channel access procedure), the UE can perform potentially additional channel access procedure before the remaining transmission occasion(s) (e.g., with index larger than k) to transmit.

In one example, if the next transmission(s) is contiguous (e.g., without time domain gap), the transmission(s) can start without performing channel access procedure.

In another example, if the next transmission(s) is non-contiguous, and gap is within a threshold (e.g., 16 μs or 25 μs), the transmission(s) can start without performing channel access procedure.

In yet another example, if the next transmission(s) is non-contiguous, the transmission(s) can start if the channel is sensed to be idle in a Type 2 (e.g., Type 2A or Type 2B) channel access procedure immediately before the transmission(s).

In yet another example, if the next transmission(s) is non-contiguous, the transmission(s) can start if the channel is continuously sensed to be idle after the k-th transmission and also sensed to be idle in a Type 2 (e.g., Type 2A or Type 2B) channel access procedure immediately before the transmission(s).

In more embodiments of this disclosure, a UE (e.g., 116) may switch from a Type 1 SL channel access procedure to a Type 2 SL channel access procedure for its corresponding SL transmission(s), upon acquiring the channel occupancy information.

In one example, the Type 2 SL channel access procedure can be a Type 2A channel access procedure.

In another example, if the UE (e.g., UE 116) can identify the gap between the corresponding SL transmission(s) and its previous transmission is 16 μs, the Type 2 SL channel access procedure can be a Type 2B channel access procedure.

In yet another example, if the UE can identify the gap between the corresponding SL transmission(s) and its previous transmission is within 16 μs, the Type 2 SL channel access procedure can be a Type 2C channel access procedure.

In one example, the switching of channel access procedure can be applied with a condition that the UE (e/g/. UE 116) can determine itself as a responding UE to share the channel occupancy based on the reception of the channel occupancy information, e.g., by determining itself as a receiver of the SL transmission that include the channel occupancy information, or by determining itself to be included in a set of identification(s) that can share the channel occupancy.

In another example, the switching of channel access procedure can be applied with a condition that the corresponding SL transmission(s) is located within the time duration provided by the channel occupancy information (e.g., within the remaining channel occupancy time).

In yet another example, the switching of channel access procedure can be applied with a condition that the corresponding SL transmission(s) is located within the available RB-sets provided by the channel occupancy information (e.g., within the RB-sets of the remaining channel occupancy).

In yet another example, the switching of channel access procedure can be applied with a condition that the channel access priority class (CAPC) of the corresponding SL transmission(s) is same or smaller than the CAPC provided by or associated with the channel occupancy information.

In yet another example, if there is no information on the CAPC provided by or associated with the channel occupancy information, the UE may assume any CAPC provided by or associated with the channel occupancy information. For instance, the switching of channel access procedure can be always applicable without constraint on the CAPC of the corresponding SL transmission(s).

In one example, CP extension is not applied for the corresponding SL transmission(s).

In another example, a default CP extension value is applied for the corresponding SL transmission(s).

In examples, the channel occupancy information can be included in a SCI.

In other examples, the channel occupancy information can be included in a DCI.

In more examples, the channel occupancy information can be included in a MAC CE.

In another embodiment of this disclosure, when a UE (e.g., UE 116) is performing a Type 1 SL channel access procedure with a counter N, and N>0, the UE may not decrement N during the sensing slot duration(s) that overlaps with SL discovery burst(s).

In one example, SL discovery burst(s) includes S-SS/PSBCH block(s), and the transmission of SL discovery burst(s) may use Type 2A channel access procedure to access the channel (e.g., initiate a channel occupancy), when the duty cycle and transmission duration requirements for the SL discovery burst(s) are satisfied.

In another embodiment of this disclosure, when a UE (e.g., UE 116) determines to perform a first Type 1 SL channel access procedure associated with a CAPC p₁ for a SL transmission (e.g., based on an indication from a SCI and/or a DCI, or the UE initiates a channel occupancy), and the UE has an ongoing second Type 1 SL channel access procedure associated with a CAPC p₂ before the starting time of the SL transmission, the UE can determine to use either the first or the second Type 1 SL channel access procedure based on the type of the SL transmission and/or the CAPC values (e.g., p₁ and p₂).

For another example, if p₁≤p₂, the UE can perform the transmission after the ongoing second Type 1 SL channel access procedure succeeds (e.g., the UE can access the channel after the channel access procedure). This example can be applicable when the SL transmission is PSSCH/PSCCH, when the SL transmission is not S-SS/PSBCH block(s) or PSFCH, or when the SL transmission is any SL transmission.

For one example, when the SL transmission is S-SS/PSBCH block(s), and/or PSFCH, the UE can perform the transmission after the ongoing second Type 1 SL channel access procedure succeeds (e.g., the UE can access the channel after the channel access procedure).

For yet another example, if p₁>p₂, the UE can terminate the ongoing second Type 1 SL channel access procedure and perform the first Type 1 SL channel access procedure to perform the SL transmission (e.g., the UE can access the channel after the channel access procedure). This example can be applicable when the SL transmission is PSSCH/PSCCH, when the SL transmission is not S-SS/PSBCH block(s) or PSFCH, or when the SL transmission is any SL transmission.

In another embodiment of this disclosure, a UE (e.g., UE 116) may indicate a Type 2 SL channel access procedure (e.g., in a SCI) for a responding UE to perform SL transmission(s) in the channel occupancy initiated by the UE, with at least one of the following example conditions satisfied.

In one example, the SL transmission(s) occur within a time interval starting at t₀ and ending at t₀+T_{mcot,p}+T_{g}.

For example, t₀ is the time instant that the initiating UE starts a SL transmission within the initiated channel occupancy after Type 1 SL channel access procedure.

For another example, T_{mcot,p} is the maximum channel occupancy time associated with a CAPC p.

For yet another example, T_{g} is the total duration of all gaps between SL transmissions (e.g., there could be a further restriction that the gap duration is greater than 25 μs).

In another example, the SL transmission(s) occur within a time interval starting at to and ending at t₀+T_{mcot,p}.

For one instance, t₀ is the time instant that the initiating UE (e.g., 116) starts a SL transmission within the initiated channel occupancy after Type 1 SL channel access procedure.

For another instance, T_{mcot,p} is the maximum channel occupancy time associated with a CAPC p.

In one example, the SL transmission(s) can be at least one from a S-SS/PSBCH block, a PSFCH, or a PSSCH/PSCCH transmission.

In one example, the UE (e.g., UE 116) can indicate Type 2 SL channel access procedure for the SL transmission(s) after it has performed its own SL transmission on the channel(s). For instance, its own SL transmission can be at least one from a S-SS/PSBCH block, a PSFCH, or a PSSCH/PSCCH transmission.

In one example, the UE can indicate a Type 2A SL channel access procedure, if the SL transmission(s) applicable for the Type 2A SL channel access procedure has a gap same as or larger than 25 μs from the UE's own transmission on the channel(s).

In another example, the UE can indicate a Type 2B SL channel access procedure, if the SL transmission(s) applicable for the Type 2B SL channel access procedure has a gap same as 16 μs from the UE's own transmission on the channel(s).

In yet another example, the UE can indicate a Type 2C SL channel access procedure, if the SL transmission(s) applicable for the Type 2C SL channel access procedure has a gap no larger than 16 μs from the UE's own transmission on the channel(s).

In one example, a UE can select contiguous resources for SL transmission(s) between the interval as exemplified in the embodiment whenever possible.

FIG. 8 illustrates a diagram 800 of SL transmission bursts according to embodiments of this disclosure. The embodiment of the diagram 800 illustrated in FIG. 8 is for illustration only. FIG. 8 does not limit the scope of this disclosure to any particular implementation of the diagram 800. The SL transmission bursts illustrated by diagram 800 may be implemented by a UE, (e.g., UE 116), in a wireless network system (e.g., 100).

In one embodiment, a SL transmission burst can be defined such that no channel access procedure (e.g., sensing of the channel) is performed within the SL transmission burst.

For example, such as SL transmission (SL TX) burst 801, a set of SL transmissions from a same transmitter UE (e.g., UE 116) can be defined as a SL transmission burst, if the gap between any of the neighboring two SL transmissions is no larger than, or smaller than, a threshold.

In one example, the threshold can be predefined as 16 μs. In another example, the threshold can be predefined as 25 μs. In yet another example, the threshold can be pre-configured.

For another example, such as SL transmission burst 802, a set of SL transmissions from a same transmitter UE (e.g., UE 116) can be defined as a SL transmission burst, if there is no gap between any of the neighboring two SL transmissions. This example can be considered as a special case of SL TX 801, when considering the threshold as 0.

As used herein, a SL transmission burst can also be referred to as a SL burst or a SL transmission.

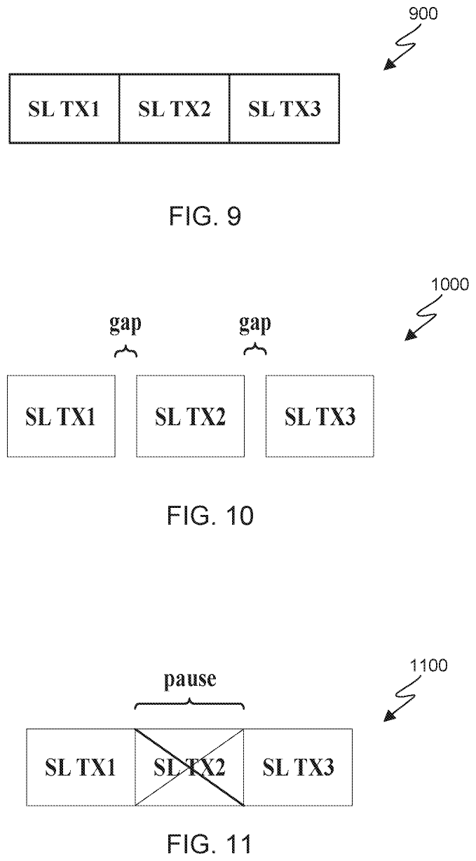

FIG. 9 illustrates a diagram 900 of continuous SL transmissions according to embodiments of this disclosure. The embodiment of the diagram 900 illustrated in FIG. 9 is for illustration only. FIG. 9 does not limit the scope of this disclosure to any particular implementation of the diagram 900. The contiguous SL transmission illustrated by diagram 900 may be implemented by a UE, (e.g., UE 116), in a wireless network system (e.g., 100).

In embodiments of this disclosure, as illustrated by FIG. 9, when a UE (e.g., UE 116) intends to transmit a set of SL transmissions (or a set of SL transmission bursts), wherein the set of SL transmissions (or the set of SL transmission bursts) are contiguous (e.g., no time domain gap between any two neighboring transmissions or transmission bursts), at least one of the following examples can apply. For one further aspect, the SL transmission(s) are within a same channel occupancy. For another further aspect, the CAPC of the SL transmission(s) is same or smaller than the CAPC of the channel occupancy.

In one example, the set of SL transmissions (or the set of SL transmission bursts) are PSCCH/PSSCH transmissions from the UE (e.g., the UE reserves a number of continuous slots for transmission, and the guard symbols are filled by repetition, and/or rate matching, and/or CP extension).

In another example, the set of SL transmissions (or the set of SL transmission bursts) can be PSCCH/PSSCH transmissions from the UE (e.g., 116), together with potential PSFCH transmissions from the same UE.

In yet another example, the set of SL transmissions (or the set of SL transmission bursts) can be PSCCH/PSSCH transmissions from the UE, together with potential S-SS/PSBCH block transmissions from the same UE.

In yet another example, the set of SL transmissions (or the set of SL transmission bursts) can be any SL transmissions from the same UE.

In one example, when the set of SL transmissions (or the set of SL transmission bursts) are contiguous (e.g., no time domain gap between any two neighboring transmissions or transmission bursts), the UE can perform Type 1 SL channel access procedure before the first transmission (or transmission burst) in the set of SL transmissions (or the set of SL transmission bursts), and if the Type 1 SL channel access procedure is performed successfully, the UE can perform the first transmission (or transmission burst). The UE can transmit the remaining transmissions (or transmission bursts) without performing channel access procedure, wherein the remaining transmissions (or transmission bursts) are within the channel occupancy associated with the Type 1 SL channel access procedure.

In another example, when the set of SL transmissions (or the set of SL transmission bursts) are contiguous (e.g., no time domain gap between any two neighboring transmissions or transmission bursts), the UE can perform Type 1 SL channel access procedure before the first transmission (or transmission burst) in the set of SL transmissions (or the set of SL transmission bursts), and if the Type 1 SL channel access procedure is not performed successfully (e.g., the channel cannot be accessed), the UE may not perform the first transmission (or transmission burst). The UE can keep performing Type 1 SL channel access procedure before the next transmission (or transmission burst) in the set of SL transmissions (or the set of SL transmission bursts).

In yet another example, when the set of SL transmissions (or the set of SL transmission bursts) are contiguous (e.g., no time domain gap between any two neighboring transmissions or transmission bursts), and the UE identifies to perform Type 2A SL channel access procedure before the first transmission (or transmission burst) in the set of SL transmissions (or the set of SL transmission bursts) (e.g., based on an indication in a SCI or DCI, or based on knowing the transmission is within a channel occupancy shared to the UE and the gap from previous transmission satisfies the condition to use Type 2A SL channel access procedure), and if the Type 2A SL channel access procedure is performed successfully, the UE can perform the first transmission (or transmission burst). The UE can transmit the remaining transmissions (or transmission bursts) without performing channel access procedure, wherein the remaining transmissions (or transmission bursts) are within the channel occupancy shared to the UE.

In yet another example, when the set of SL transmissions (or the set of SL transmission bursts) are contiguous (e.g., no time domain gap between any two neighboring transmissions or transmission bursts), and the UE (e.g., UE 116) identifies to perform Type 2A SL channel access procedure before the first transmission (or transmission burst) in the set of SL transmissions (or the set of SL transmission bursts) (e.g., based on an indication in a SCI or DCI, or based on knowing the transmission is within a channel occupancy shared to the UE and the gap from previous transmission satisfies the condition to use Type 2A SL channel access procedure), and if the Type 2A SL channel access procedure is not performed successfully (e.g., the channel cannot be accessed), the UE may not perform the first transmission (or transmission burst). The UE can perform Type 2A SL channel access procedure before the next transmission (or transmission burst) in the set of SL transmissions (or the set of SL transmission bursts), wherein the next transmission (or transmission burst) is within the channel occupancy shared to the UE.

In yet another example, when the set of SL transmissions (or the set of SL transmission bursts) are contiguous (e.g., no time domain gap between any two neighboring transmissions or transmission bursts), and the UE identifies to perform Type 2B SL channel access procedure before the first transmission (or transmission burst) in the set of SL transmissions (or the set of SL transmission bursts) (e.g., based on an indication in a SCI or DCI, or based on knowing the transmission is within a channel occupancy shared to the UE and the gap from previous transmission satisfies the condition to use Type 2B SL channel access procedure), and if the Type 2B SL channel access procedure is performed successfully, the UE can perform the first transmission (or transmission burst). The UE can transmit the remaining transmissions (or transmission bursts) without performing channel access procedure, wherein the remaining transmissions (or transmission bursts) are within the channel occupancy shared to the UE.

In yet another example, when the set of SL transmissions (or the set of SL transmission bursts) are contiguous (e.g., no time domain gap between any two neighboring transmissions or transmission bursts), and the UE identifies to perform Type 2B SL channel access procedure before the first transmission (or transmission burst) in the set of SL transmissions (or the set of SL transmission bursts) (e.g., based on an indication in a SCI or DCI, or based on knowing the transmission is within a channel occupancy shared to the UE and the gap from previous transmission satisfies the condition to use Type 2B SL channel access procedure), and if the Type 2B SL channel access procedure is not performed successfully (e.g., the channel cannot be accessed), the UE may not perform the first transmission (or transmission burst). The UE can perform Type 2A SL channel access procedure before the next transmission (or transmission burst) in the set of SL transmissions (or the set of SL transmission bursts), wherein the next transmission (or transmission burst) is within the channel occupancy shared to the UE.

In yet another example, when the set of SL transmissions (or the set of SL transmission bursts) are contiguous (e.g., no time domain gap between any two neighboring transmissions or transmission bursts), and the UE identifies to perform Type 2C SL channel access procedure before the first transmission (or transmission burst) in the set of SL transmissions (or the set of SL transmission bursts) (e.g., based on an indication in a SCI or DCI, or based on knowing the transmission is within a channel occupancy shared to the UE and the gap from previous transmission satisfies the condition to use Type 2C SL channel access procedure), and if the Type 2C SL channel access procedure is performed successfully, the UE can perform the first transmission (or transmission burst). The UE can transmit the remaining transmissions (or transmission bursts) without performing channel access procedure, wherein the remaining transmissions (or transmission bursts) are within the channel occupancy shared to the UE.

In yet another example, when the set of SL transmissions (or the set of SL transmission bursts) are contiguous (e.g., no time domain gap between any two neighboring transmissions or transmission bursts), and the UE identifies to perform Type 2C SL channel access procedure before the first transmission (or transmission burst) in the set of SL transmissions (or the set of SL transmission bursts) (e.g., based on an indication in a SCI or DCI, or based on knowing the transmission is within a channel occupancy shared to the UE and the gap from previous transmission satisfies the condition to use Type 2C SL channel access procedure), and if the Type 2C SL channel access procedure is not performed successfully (e.g., the channel cannot be accessed), the UE may not perform the first transmission (or transmission burst). The UE can perform Type 2A SL channel access procedure before the next transmission (or transmission burst) in the set of SL transmissions (or the set of SL transmission bursts), wherein the next transmission (or transmission burst) is within the channel occupancy shared to the UE.

FIG. 10 illustrates a diagram 1000 of non-continuous SL transmissions according to embodiments of this disclosure. The embodiment of the diagram 1000 illustrated in FIG. 10 is for illustration only. FIG. 10 does not limit the scope of this disclosure to any particular implementation of the diagram 1000. The non-contiguous SL transmission illustrated by diagram 1000 may be implemented by a UE, (e.g., UE 116), in a wireless network system (e.g., 100).

In embodiments of this disclosure, as illustrated by FIG. 10, when a UE (e.g., UE 116) intends to transmit a set of SL transmissions (or a set of SL transmission bursts), wherein the set of SL transmissions (or the set of SL transmission bursts) are non-contiguous (e.g., time domain gap between neighboring transmissions or transmission bursts), at least one of the following examples can apply. For one further aspect, the SL transmission(s) are within a same channel occupancy. For another further aspect, the CAPC of the SL transmission(s) is same or smaller than the CAPC of the channel occupancy.

In one example, the set of SL transmissions (or the set of SL transmission bursts) are PSCCH/PSSCH transmissions from the UE (e.g., the UE reserves a number of continuous slots for transmission, and the guard symbols may not be fully filled).

In another example, the set of SL transmissions (or the set of SL transmission bursts) can be PSCCH/PSSCH transmissions from the UE, together with potential PSFCH transmissions from the same UE.

In yet another example, the set of SL transmissions (or the set of SL transmission bursts) can be PSCCH/PSSCH transmissions from the UE, together with potential S-SS/PSBCH block transmissions from the same UE.

In yet another example, the set of SL transmissions (or the set of SL transmission bursts) can be any SL transmissions from the same UE.

In one example, when the set of SL transmissions (or the set of SL transmission bursts) are non-contiguous (e.g., time domain gap between neighboring transmissions or transmission bursts), and the gap(s) are all within a threshold (e.g., 16 μs or 25 μs), the UE can initiate a channel occupancy (e.g., perform Type 1 SL channel access procedure before the first transmission (or transmission burst) in the set of SL transmissions (or the set of SL transmission bursts)), and if the Type 1 SL channel access procedure is performed successfully, the UE can perform the first transmission (or transmission burst). The UE can transmit the remaining transmissions (or transmission bursts) without performing channel access procedure, wherein the remaining transmissions (or transmission bursts) are within the channel occupancy associated with the Type 1 SL channel access procedure.

In other examples, when the set of SL transmissions (or the set of SL transmission bursts) are non-contiguous (e.g., time domain gap between neighboring transmissions or transmission bursts), and the gap(s) are all within a threshold (e.g., 16 μs or 25 μs), the UE can initiate a channel occupancy (e.g., perform Type 1 SL channel access procedure before the first transmission (or transmission burst) in the set of SL transmissions (or the set of SL transmission bursts)), and if the Type 1 SL channel access procedure is not performed successfully (e.g., channel cannot be accessed), the UE may not perform the first transmission (or transmission burst). The UE can keep performing Type 1 SL channel access procedure before the next transmission (or transmission burst) in the set of SL transmissions (or the set of SL transmission bursts).

In some examples, when the set of SL transmissions (or the set of SL transmission transmission bursts), and the gap(s) are all within a threshold (e.g., 16 μs or 25 μs), and the UE identifies to perform Type 2A SL channel access procedure before the first transmission (or transmission burst) in the set of SL transmissions (or the set of SL transmission bursts) (e.g., based on an indication in a SCI or DCI, or based on knowing the transmission is within a channel occupancy shared to the UE and the gap from previous transmission satisfies the condition to use Type 2A SL channel access procedure), and if the Type 2A SL channel access procedure is performed successfully, the UE can perform the first transmission (or transmission burst). The UE can transmit the remaining transmissions (or transmission bursts) without performing channel access procedure, wherein the remaining transmissions (or transmission bursts) are within the channel occupancy shared to the UE.

In another example, when the set of SL transmissions (or the set of SL transmission bursts) are non-contiguous (e.g., time domain gap between neighboring transmissions or transmission bursts), and the gap(s) are all within a threshold (e.g., 16 μs or 25 μs), and the UE identifies to perform Type 2A SL channel access procedure before the first transmission (or transmission burst) in the set of SL transmissions (or the set of SL transmission bursts) (e.g., based on an indication in a SCI or DCI, or based on knowing the transmission is within a channel occupancy shared to the UE and the gap from previous transmission satisfies the condition to use Type 2A SL channel access procedure), and if the Type 2A SL channel access procedure is not performed successfully, the UE may not perform the first transmission (or transmission burst). The UE can keep performing Type 2A SL channel access procedure before the next transmission (or transmission burst) in the set of SL transmissions (or the set of SL transmission bursts), wherein the next transmission (or transmission burst) is within the channel occupancy shared to the UE.

In yet more examples, when the set of SL transmissions (or the set of SL transmission transmission bursts), and the gap(s) are all within a threshold (e.g., 16 μs or 25 μs), and the UE identifies to perform Type 2B SL channel access procedure before the first transmission (or transmission burst) in the set of SL transmissions (or the set of SL transmission bursts) (e.g., based on an indication in a SCI or DCI, or based on knowing the transmission is within a channel occupancy shared to the UE and the gap from previous transmission satisfies the condition to use Type 2B SL channel access procedure), and if the Type 2B SL channel access procedure is performed successfully, the UE can perform the first transmission (or transmission burst). The UE can transmit the remaining transmissions (or transmission bursts) without performing channel access procedure, wherein the remaining transmissions (or transmission bursts) are within the channel occupancy shared to the UE.

In yet another example, when the set of SL transmissions (or the set of SL transmission bursts) are non-contiguous (e.g., time domain gap between neighboring transmissions or transmission bursts), and the gap(s) are all within a threshold (e.g., 16 μs or 25 μs), and the UE identifies to perform Type 2B SL channel access procedure before the first transmission (or transmission burst) in the set of SL transmissions (or the set of SL transmission bursts) (e.g., based on an indication in a SCI or DCI, or based on knowing the transmission is within a channel occupancy shared to the UE and the gap from previous transmission satisfies the condition to use Type 2B SL channel access procedure), and if the Type 2B SL channel access procedure is not performed successfully, the UE may not perform the first transmission (or transmission burst). The UE can perform Type 2A SL channel access procedure before the next transmission (or transmission burst) in the set of SL transmissions (or the set of SL transmission bursts), wherein the next transmission (or transmission burst) is within the channel occupancy shared to the UE.

In yet another example, when the set of SL transmissions (or the set of SL transmission transmission bursts), and the gap(s) are all within a threshold (e.g., 16 μs or 25 μs), and the UE identifies to perform Type 2C SL channel access procedure before the first transmission (or transmission burst) in the set of SL transmissions (or the set of SL transmission bursts) (e.g., based on an indication in a SCI or DCI, or based on knowing the transmission is within a channel occupancy shared to the UE and the gap from previous transmission satisfies the condition to use Type 2C SL channel access procedure), and if the Type 2C SL channel access procedure is performed successfully, the UE can perform the first transmission (or transmission burst). The UE can transmit the remaining transmissions (or transmission bursts) without performing channel access procedure, wherein the remaining transmissions (or transmission bursts) are within the channel occupancy shared to the UE.

In yet another example, when the set of SL transmissions (or the set of SL transmission bursts) are non-contiguous (e.g., time domain gap between neighboring transmissions or transmission bursts), and the gap(s) are all within a threshold (e.g., 16 μs or 25 μs), and the UE identifies to perform Type 2C SL channel access procedure before the first transmission (or transmission burst) in the set of SL transmissions (or the set of SL transmission bursts) (e.g., based on an indication in a SCI or DCI, or based on knowing the transmission is within a channel occupancy shared to the UE and the gap from previous transmission satisfies the condition to use Type 2C SL channel access procedure), and if the Type 2C SL channel access procedure is not performed successfully, the UE may not perform the first transmission (or transmission burst). The UE can perform Type 2A SL channel access procedure before the next transmission (or transmission burst) in the set of SL transmissions (or the set of SL transmission bursts), wherein the next transmission (or transmission burst) is within the channel occupancy shared to the UE.

In an additional example, when the set of SL transmissions (or the set of SL transmission bursts) are non-contiguous (e.g., there are time domain gaps between neighboring transmissions or transmission bursts, wherein potentially with a further requirement that the gap(s) are larger than or no less than a threshold (e.g., 16 μs or 25 μs)), the UE can initiate a channel occupancy (e.g., by performing Type 1 SL channel access procedure before the first transmission (or transmission burst) in the set of SL transmissions (or the set of SL transmission bursts)), and if the Type 1 SL channel access procedure is performed successfully, the UE can perform the first transmission (or transmission burst). The UE can transmit the remaining transmissions (or transmission bursts) without performing channel access procedure, wherein the remaining transmissions (or transmission bursts) are within the channel occupancy associated with the Type 1 SL channel access procedure.

In another example, when the set of SL transmissions (or the set of SL transmission bursts) are non-contiguous (e.g., there are time domain gaps between neighboring transmissions or transmission bursts, wherein potentially with a further requirement that the gap(s) are larger than or no less than a threshold (e.g., 16 μs or 25 μs)), the UE can initiate a channel occupancy (e.g., by performing Type 1 SL channel access procedure before the first transmission (or transmission burst) in the set of SL transmissions (or the set of SL transmission bursts)), and if the Type 1 SL channel access procedure is performed successfully, the UE can perform the first transmission (or transmission burst). The UE can perform a Type 2 SL channel access procedure before the further transmissions (or transmission bursts), wherein the further transmissions (or transmission bursts) are within the channel occupancy associated with the Type 1 SL channel access procedure.

In one example, the UE can perform a Type 2A SL channel access procedure when the gap is no less than 25 μs. In another example, the UE can perform a Type 2B SL channel access procedure when the gap is 16 μs. In yet another example, the UE can perform a Type 2C SL channel access procedure when the gap is no larger than 16 μs. In yet another example, if a Type 2 channel access procedure is not performed successfully, the UE may not perform the succeeding SL transmission (or transmission burst), and the UE can perform a Type 2A channel access procedure before the next SL transmission (or transmission burst) after the succeeding SL transmission (or transmission burst), e.g., regardless the gap size, wherein the next SL transmission (or transmission burst) after the succeeding SL transmission (or transmission burst) is within the channel occupancy associated with the Type 1 SL channel access procedure.

In yet more examples, if a Type 2 channel access procedure is not performed successfully, the UE may not perform the succeeding SL transmission (or transmission burst), and the UE can perform a Type 1 channel access procedure before the next SL transmission (or transmission burst) after the succeeding SL transmission (or transmission burst), e.g., wherein the next SL transmission (or transmission burst) after the succeeding SL transmission (or transmission burst) is not within the channel occupancy associated with the Type 1 SL channel access procedure that initiates the channel occupancy with the first transmission.

In other examples, when the set of SL transmissions (or the set of SL transmission bursts) are non-contiguous (e.g., there are time domain gaps between neighboring transmissions or transmission bursts, wherein potentially with a further requirement that the gap(s) are larger than or no less than a threshold (e.g., 16 μs or 25 μs)), the UE can initiate a channel occupancy (e.g., by performing Type 1 SL channel access procedure before the first transmission (or transmission burst) in the set of SL transmissions (or the set of SL transmission bursts)), and if the Type 1 SL channel access procedure is performed successfully, the UE can perform the first transmission (or transmission burst). During the gap of the non-contiguous SL transmissions where the UE does not perform any transmission, if the channel is further sensed to be continuously idle after the first transmission by the UE, the UE can perform a successful Type 2 (e.g., Type 2A or Type 2B) SL channel access procedure before the further transmissions (or transmission bursts) after the first transmission to access the channel, wherein the further transmissions (or transmission bursts) are within the channel occupancy associated with the Type 1 SL channel access procedure (e.g., the CAPC of the further transmissions shall be complied with the CAPC of the channel occupancy, e.g., same or smaller than the CAPC of the channel occupancy).

In a further example, if the channel is not sensed to be continuously idle after the first transmission by the UE or the further transmissions (or transmission bursts) are not within the channel occupancy associated with the Type 1 SL channel access procedure, the UE can perform a Type 1 channel access procedure for further SL transmissions (or transmission bursts).

In yet more examples, when the set of SL transmissions (or the set of SL transmission bursts) are non-contiguous (e.g., there are time domain gaps between neighboring transmissions or transmission bursts, wherein potentially with a further requirement that the gap(s) are larger than or no less than a threshold (e.g., 16 μs or 25 μs)), the UE (e.g., UE 116) can perform Type 1 SL channel access procedure before the first transmission (or transmission burst) in the set of SL transmissions (or the set of SL transmission bursts), and if the Type 1 SL channel access procedure is not performed successfully, the UE may not perform the first transmission (or transmission burst). The UE can keep performing Type 1 SL channel access procedure before the next transmission (or transmission burst) in the set of SL transmissions (or the set of SL transmission bursts).

In some examples, when the set of SL transmissions (or the set of SL transmission bursts) are non-contiguous (e.g., there are time domain gaps between neighboring transmissions or transmission bursts, wherein potentially with a further requirement that the gap(s) are larger than or no less than a threshold (e.g., 16 μs or 25 μs)), and the UE (e.g., UE 116) identifies to perform Type 2A SL channel access procedure before the first transmission (or transmission burst) in the set of SL transmissions (or the set of SL transmission bursts) (e.g., based on an indication in a SCI or DCI, or based on knowing the transmission is within a channel occupancy shared to the UE and the gap from previous transmission satisfies the condition to use Type 2A SL channel access procedure), and if the Type 2A SL channel access procedure is performed successfully, the UE can perform the first transmission (or transmission burst). The UE can transmit the remaining transmissions (or transmission bursts) without performing channel access procedure, wherein the remaining transmissions (or transmission bursts) are within the channel occupancy shared to the UE.

In another example, when the set of SL transmissions (or the set of SL transmission bursts) are non-contiguous (e.g., there are time domain gaps between neighboring transmissions or transmission bursts, wherein potentially with a further requirement that the gap(s) are larger than or no less than a threshold (e.g., 16 μs or 25 μs)), and the UE identifies to perform Type 2A SL channel access procedure before the first transmission (or transmission burst) in the set of SL transmissions (or the set of SL transmission bursts) (e.g., based on an indication in a SCI or DCI, or based on knowing the transmission is within a channel occupancy shared to the UE and the gap from previous transmission satisfies the condition to use Type 2A SL channel access procedure), and if the Type 2A SL channel access procedure is performed successfully, the UE can perform the first transmission (or transmission burst). The UE can perform a Type 2 SL channel access procedure before the further transmissions (or transmission bursts), wherein the further transmissions (or transmission bursts) are within the channel occupancy shared to the UE.

In one further example, the UE (e.g., UE 116) can perform a Type 2A SL channel access procedure when the gap is no less than 25 μs. In other examples, the UE can perform a Type 2B SL channel access procedure when the gap is 16 μs. In some examples, the UE can perform a Type 2C SL channel access procedure when the gap is no larger than 16 μs. In yet additional examples, if a Type 2 channel access procedure is not performed successfully, the UE may not perform the succeeding SL transmission (or transmission burst), and the UE can perform a Type 2A channel access procedure before the next SL transmission (or transmission burst) after the succeeding SL transmission (or transmission burst), e.g., regardless the gap size, wherein the next SL transmission (or transmission burst) after the succeeding SL transmission (or transmission burst) is within the channel occupancy associated with the Type 1 SL channel access procedure. In some examples, if a Type 2 channel access procedure is not performed successfully, the UE may not perform the succeeding SL transmission (or transmission burst), and the UE can perform a Type 1 channel access procedure before the next SL transmission (or transmission burst) after the succeeding SL transmission (or transmission burst), e.g., wherein the next SL transmission (or transmission burst) after the succeeding SL transmission (or transmission burst) is not within the channel occupancy associated with the Type 1 SL channel access procedure that initiates the channel occupancy with the first transmission.

In yet another example, when the set of SL transmissions (or the set of SL transmission bursts) are non-contiguous (e.g., there are time domain gaps between neighboring transmissions or transmission bursts, wherein potentially with a further requirement that the gap(s) are larger than or no less than a threshold (e.g., 16 μs or 25 μs)), and the UE (e.g., UE 116) identifies to perform Type 2A SL channel access procedure before the first transmission (or transmission burst) in the set of SL transmissions (or the set of SL transmission bursts) (e.g., based on an indication in a SCI or DCI, or based on knowing the transmission is within a channel occupancy shared to the UE and the gap from previous transmission satisfies the condition to use Type 2A SL channel access procedure), and if the Type 2A SL channel access procedure is performed successfully, the UE can perform the first transmission (or transmission burst). If the channel is further sensed to be continuously idle after the first transmission by the UE, the UE can perform a Type 2 (e.g., Type 2A or Type 2B) SL channel access procedure before the further transmissions (or transmission bursts), wherein the further transmissions (or transmission bursts) are within the channel occupancy.

In one further example, if the channel is not sensed to be continuously idle after the first transmission by the UE or the further transmissions (or transmission bursts) are not within the channel occupancy, the UE can perform a Type 1 channel access procedure for further SL transmissions (or transmission bursts).

In some examples, when the set of SL transmissions (or the set of SL transmission bursts) are non-contiguous (e.g., there are time domain gaps between neighboring transmissions or transmission bursts, wherein potentially with a further requirement that the gap(s) are larger than or no less than a threshold (e.g., 16 μs or 25 μs)), and the UE identifies to perform Type 2A SL channel access procedure before the first transmission (or transmission burst) in the set of SL transmissions (or the set of SL transmission bursts) (e.g., based on an indication in a SCI or DCI, or based on knowing the transmission is within a channel occupancy shared to the UE and the gap from previous transmission satisfies the condition to use Type 2A SL channel access procedure), and if the Type 2A SL channel access procedure is not performed successfully, the UE may not perform the first transmission (or transmission burst). The UE can keep performing Type 2A SL channel access procedure before the next transmission (or transmission burst) in the set of SL transmissions (or the set of SL transmission bursts), wherein the next transmission (or transmission burst) is within the channel occupancy shared to the UE.

For example, when the set of SL transmissions (or the set of SL transmission bursts) are non-contiguous (e.g., there are time domain gaps between neighboring transmissions or transmission bursts, wherein potentially with a further requirement that the gap(s) are larger than or no less than a threshold (e.g., 16 μs or 25 μs)), and the UE identifies to perform Type 2B SL channel access procedure before the first transmission (or transmission burst) in the set of SL transmissions (or the set of SL transmission bursts) (e.g., based on an indication in a SCI or DCI, or based on knowing the transmission is within a channel occupancy shared to the UE and the gap from previous transmission satisfies the condition to use Type 2B SL channel access procedure), and if the Type 2B SL channel access procedure is performed successfully, the UE can perform the first transmission (or transmission burst). The UE can transmit the remaining transmissions (or transmission bursts) without performing channel access procedure, wherein the remaining transmissions (or transmission bursts) are within the channel occupancy shared to the UE.

In yet another example, when the set of SL transmissions (or the set of SL transmission bursts) are non-contiguous (e.g., there are time domain gaps between neighboring transmissions or transmission bursts, wherein potentially with a further requirement that the gap(s) are larger than or no less than a threshold (e.g., 16 μs or 25 μs)), and the UE identifies to perform Type 2B SL channel access procedure before the first transmission (or transmission burst) in the set of SL transmissions (or the set of SL transmission bursts) (e.g., based on an indication in a SCI or DCI, or based on knowing the transmission is within a channel occupancy shared to the UE and the gap from previous transmission satisfies the condition to use Type 2B SL channel access procedure), and if the Type 2B SL channel access procedure is performed successfully, the UE can perform the first transmission (or transmission burst). The UE can perform a Type 2 SL channel access procedure before the further transmissions (or transmission bursts), wherein the further transmissions (or transmission bursts) are within the channel occupancy shared to the UE.

In a further example, the UE can perform a Type 2A SL channel access procedure when the gap is no less than 25 μs. In another example, the UE can perform a Type 2B SL channel access procedure when the gap is 16 μs. In yet another example, the UE can perform a Type 2C SL channel access procedure when the gap is no larger than 16 μs. In more examples, if a Type 2 channel access procedure is not performed successfully, the UE may not perform the succeeding SL transmission (or transmission burst), and the UE can perform a Type 2A channel access procedure before the next SL transmission (or transmission burst) after the succeeding SL transmission (or transmission burst), e.g., regardless the gap size, wherein the next SL transmission (or transmission burst) after the succeeding SL transmission (or transmission burst) is within the channel occupancy associated with the Type 1 SL channel access procedure. In yet additional examples, if a Type 2 channel access procedure is not performed successfully, the UE may not perform the succeeding SL transmission (or transmission burst), and the UE can perform a Type 1 channel access procedure before the next SL transmission (or transmission burst) after the succeeding SL transmission (or transmission burst), e.g., wherein the next SL transmission (or transmission burst) after the succeeding SL transmission (or transmission burst) is not within the channel occupancy associated with the Type 1 SL channel access procedure that initiates the channel occupancy with the first transmission.

In yet another example, when the set of SL transmissions (or the set of SL transmission bursts) are non-contiguous (e.g., there are time domain gaps between neighboring transmissions or transmission bursts, wherein potentially with a further requirement that the gap(s) are larger than or no less than a threshold (e.g., 16 μs or 25 μs)), and the UE identifies to perform Type 2B SL channel access procedure before the first transmission (or transmission burst) in the set of SL transmissions (or the set of SL transmission bursts) (e.g., based on an indication in a SCI or DCI, or based on knowing the transmission is within a channel occupancy shared to the UE and the gap from previous transmission satisfies the condition to use Type 2B SL channel access procedure), and if the Type 2B SL channel access procedure is performed successfully, the UE can perform the first transmission (or transmission burst). If the channel is further sensed to be continuously idle after the first transmission by the UE, the UE can perform a Type 2 (e.g., Type 2A or Type 2B) SL channel access procedure before the further transmissions (or transmission bursts), wherein the further transmissions (or transmission bursts) are within the channel occupancy.

In a further example, if the channel is not sensed to be continuously idle after the first transmission by the UE or the further transmissions (or transmission bursts) are not within the channel occupancy, the UE can perform a Type 1 channel access procedure for further SL transmissions (or transmission bursts).

In more examples of this disclosure, when the set of SL transmissions (or the set of SL transmission bursts) are non-contiguous (e.g., there are time domain gaps between neighboring transmissions or transmission bursts, wherein potentially with a further requirement that the gap(s) are larger than or no less than a threshold (e.g., 16 μs or 25 μs)), and the UE identifies to perform Type 2B SL channel access procedure before the first transmission (or transmission burst) in the set of SL transmissions (or the set of SL transmission bursts) (e.g., based on an indication in a SCI or DCI, or based on knowing the transmission is within a channel occupancy shared to the UE and the gap from previous transmission satisfies the condition to use Type 2B SL channel access procedure), and if the Type 2B SL channel access procedure is not performed successfully, the UE may not perform the first transmission (or transmission burst). The UE can perform Type 2A SL channel access procedure before the next transmission (or transmission burst) in the set of SL transmissions (or the set of SL transmission bursts), wherein the next transmission (or transmission burst) is within the channel occupancy shared to the UE.

In added examples, when the set of SL transmissions (or the set of SL transmission bursts) are non-contiguous (e.g., there are time domain gaps between neighboring transmissions or transmission bursts, wherein potentially with a further requirement that the gap(s) are larger than or no less than a threshold (e.g., 16 μs or 25 μs)), and the UE identifies to perform Type 2C SL channel access procedure before the first transmission (or transmission burst) in the set of SL transmissions (or the set of SL transmission bursts) (e.g., based on an indication in a SCI or DCI, or based on knowing the transmission is within a channel occupancy shared to the UE and the gap from previous transmission satisfies the condition to use Type 2C SL channel access procedure), and if the Type 2C SL channel access procedure is performed successfully, the UE can perform the first transmission (or transmission burst). The UE can transmit the remaining transmissions (or transmission bursts) without performing channel access procedure, wherein the remaining transmissions (or transmission bursts) are within the channel occupancy shared to the UE.

In some examples, when the set of SL transmissions (or the set of SL transmission bursts) are non-contiguous (e.g., there are time domain gaps between neighboring transmissions or transmission bursts, wherein potentially with a further requirement that the gap(s) are larger than or no less than a threshold (e.g., 16 μs or 25 μs)), and the UE identifies to perform Type 2C SL channel access procedure before the first transmission (or transmission burst) in the set of SL transmissions (or the set of SL transmission bursts) (e.g., based on an indication in a SCI or DCI, or based on knowing the transmission is within a channel occupancy shared to the UE and the gap from previous transmission satisfies the condition to use Type 2C SL channel access procedure), and if the Type 2C SL channel access procedure is performed successfully, the UE can perform the first transmission (or transmission burst). The UE can perform a Type 2 SL channel access procedure before the further transmissions (or transmission bursts), wherein the further transmissions (or transmission bursts) are within the channel occupancy shared to the UE.

In one further example, the UE can perform a Type 2A SL channel access procedure when the gap is no less than 25 μs. In more examples, the UE can perform a Type 2B SL channel access procedure when the gap is 16 μs. In yet another example, the UE can perform a Type 2C SL channel access procedure when the gap is no larger than 16 μs. In additional examples, if a Type 2 channel access procedure is not performed successfully, the UE may not perform the succeeding SL transmission (or transmission burst), and the UE can perform a Type 2A channel access procedure before the next SL transmission (or transmission burst) after the succeeding SL transmission (or transmission burst), e.g., regardless the gap size, wherein the next SL transmission (or transmission burst) after the succeeding SL transmission (or transmission burst) is within the channel occupancy associated with the Type 1 SL channel access procedure. In yet some other examples, if a Type 2 channel access procedure is not performed successfully, the UE may not perform the succeeding SL transmission (or transmission burst), and the UE can perform a Type 1 channel access procedure before the next SL transmission (or transmission burst) after the succeeding SL transmission (or transmission burst), e.g., wherein the next SL transmission (or transmission burst) after the succeeding SL transmission (or transmission burst) is not within the channel occupancy associated with the Type 1 SL channel access procedure that initiates the channel occupancy with the first transmission.

In yet another example, when the set of SL transmissions (or the set of SL transmission bursts) are non-contiguous (e.g., there are time domain gaps between neighboring transmissions or transmission bursts, wherein potentially with a further requirement that the gap(s) are larger than or no less than a threshold (e.g., 16 μs or 25 μs)), and the UE identifies to perform Type 2C SL channel access procedure before the first transmission (or transmission burst) in the set of SL transmissions (or the set of SL transmission bursts) (e.g., based on an indication in a SCI or DCI, or based on knowing the transmission is within a channel occupancy shared to the UE and the gap from previous transmission satisfies the condition to use Type 2C SL channel access procedure), and if the Type 2C SL channel access procedure is performed successfully, the UE can perform the first transmission (or transmission burst). If the channel is further sensed to be continuously idle after the first transmission by the UE, the UE can perform a Type 2 (e.g., Type 2A or Type 2B) SL channel access procedure before the further transmissions (or transmission bursts), wherein the further transmissions (or transmission bursts) are within the channel occupancy.

In more further examples, if the channel is not sensed to be continuously idle after the first transmission by the UE or the further transmissions (or transmission bursts) are not within the channel occupancy, the UE can perform a Type 1 channel access procedure for further SL transmissions (or transmission bursts).

In additional examples, when the set of SL transmissions (or the set of SL transmission bursts) are non-contiguous (e.g., there are time domain gaps between neighboring transmissions or transmission bursts, wherein potentially with a further requirement that the gap(s) are larger than or no less than a threshold (e.g., 16 μs or 25 μs)), and the UE identifies to perform Type 2C SL channel access procedure before the first transmission (or transmission burst) in the set of SL transmissions (or the set of SL transmission bursts) (e.g., based on an indication in a SCI or DCI, or based on knowing the transmission is within a channel occupancy shared to the UE and the gap from previous transmission satisfies the condition to use Type 2C SL channel access procedure), and if the Type 2C SL channel access procedure is not performed successfully, the UE may not perform the first transmission (or transmission burst). The UE can perform Type 2A SL channel access procedure before the next transmission (or transmission burst) in the set of SL transmissions (or the set of SL transmission bursts), wherein the next transmission (or transmission burst) is within the channel occupancy shared to the UE.

In an example, when the set of SL transmissions (or the set of SL transmission bursts) are non-contiguous (e.g., there are time domain gaps between neighboring transmissions or transmission bursts, wherein potentially with a further requirement that the gap(s) are larger than or no less than a threshold (e.g., 16 μs or 25 μs)), and at least one SL transmission from another UE occurs within the gap(s), the UE can perform Type 1 SL channel access procedure before the first transmission (or transmission burst) in the set of SL transmissions (or the set of SL transmission bursts), and if the Type 1 SL channel access procedure is performed successfully, the UE can perform the first transmission (or transmission burst). The UE can transmit the remaining transmissions (or transmission bursts) without performing channel access procedure, after the at least one SL transmission from another UE, wherein the remaining transmissions (or transmission bursts) are within the channel occupancy associated with the Type 1 SL channel access procedure.

In further examples, the another UE (e.g., UE 114) shares the channel occupancy associated with the Type 1 SL channel access procedure and performs the at least one SL transmission from the another UE. In other examples, the at least one SL transmission from the another UE (e.g., UE 114) includes the UE (e.g., UE 116) initiating the channel occupancy as receiver (e.g., for unicast transmission) or one of the receivers (e.g., for groupcast and/or broadcast transmission). In more examples, the UE initiating the channel occupancy may need to receive the at least one SL transmission from the another UE, before transmitting further SL transmission after the at least one SL transmission from the another UE.

In yet another example of this disclosure, when the set of SL transmissions (or the set of SL transmission bursts) are non-contiguous (e.g., there are time domain gaps between neighboring transmissions or transmission bursts, wherein potentially with a further requirement that the gap(s) are larger than or no less than a threshold (e.g., 16 μs or 25 μs)), and at least one SL transmission from another UE (e.g., UE 114) occurs within the gap(s), the UE (e.g., UE 116) can perform Type 1 SL channel access procedure before the first transmission (or transmission burst) in the set of SL transmissions (or the set of SL transmission bursts), and if the Type 1 SL channel access procedure is performed successfully, the UE can perform the first transmission (or transmission burst). The UE can perform a Type 2 SL channel access procedure before the further transmissions (or transmission bursts), after the at least one SL transmission from another UE, wherein the further transmissions (or transmission bursts) are within the channel occupancy associated with the Type 1 SL channel access procedure, e.g., when the UE knows the size of the gap from the end of the at least one SL transmission from the another UE to the start of the UE's further transmission.

In a further example, the UE can perform a Type 2A SL channel access procedure when a gap is no less than 25 μs, wherein the gap is from the end of the at least one SL transmission from the another UE (e.g., UE 114) to the start of the UE's further transmission. In another example, the UE can perform a Type 2B SL channel access procedure when a gap is 16 μs, wherein the gap is from the end of the at least one SL transmission from the another UE to the start of the UE's further transmission. In some examples, the UE can perform a Type 2C SL channel access procedure when a gap is no larger than 16 μs, wherein the gap is from the end of the at least one SL transmission from the another UE to the start of the UE's further transmission. In added examples, the UE can perform a Type 2A SL channel access procedure when the UE does not know the size of gap from the end of the at least one SL transmission from the another UE to the start of the UE's further transmission.

In yet another further example, the UE may not perform further transmission when the UE does not know the size of gap from the end of the at least one SL transmission from the another UE to the start of the UE's further transmission.

In some other further examples, if a Type 2 channel access procedure is not performed successfully, the UE may not perform the succeeding SL transmission (or transmission burst), and the UE can perform a Type 2A channel access procedure before the next SL transmission (or transmission burst) after the succeeding SL transmission (or transmission burst), e.g., regardless the gap size, wherein the next SL transmission (or transmission burst) after the succeeding SL transmission (or transmission burst) is within the channel occupancy associated with the Type 1 SL channel access procedure.

In more further examples, if a Type 2 channel access procedure is not performed successfully, the UE (e.g., UE 116) may not perform the succeeding SL transmission (or transmission burst), and the UE can perform a Type 1 channel access procedure before the next SL transmission (or transmission burst) after the succeeding SL transmission (or transmission burst), e.g., wherein the next SL transmission (or transmission burst) after the succeeding SL transmission (or transmission burst) is not within the channel occupancy associated with the Type 1 SL channel access procedure that initiates the channel occupancy with the first transmission.

In yet some other further examples, the another UE (e.g., UE 114) shares the channel occupancy associated with the Type 1 SL channel access procedure and performs the at least one SL transmission from the another UE.

In another example, the at least one SL transmission from the another UE (e.g., UE 114) includes the UE (e.g., UE 116) initiating the channel occupancy as receiver (e.g., for unicast transmission) or one of the receivers (e.g., for groupcast and/or broadcast transmission).

In a further example, the UE (e.g., UE 116) initiating the channel occupancy may need to receive the at least one SL transmission from the another UE (e.g., UE 114), before transmitting further SL transmission after the at least one SL transmission from the another UE.

In yet another example, when the set of SL transmissions (or the set of SL transmission bursts) are non-contiguous (e.g., there are time domain gaps between neighboring transmissions or transmission bursts, wherein potentially with a further requirement that the gap(s) are larger than or no less than a threshold (e.g., 16 μs or 25 μs)), and at least one SL transmission from another UE occurs within the gap(s), the UE can perform Type 1 SL channel access procedure before the first transmission (or transmission burst) in the set of SL transmissions (or the set of SL transmission bursts), and if the Type 1 SL channel access procedure is performed successfully, the UE can perform the first transmission (or transmission burst). If the channel is further sensed to be continuously idle after the first transmission by the UE, the UE can perform a Type 2 (e.g., Type 2A or Type 2B) SL channel access procedure before the further transmissions (or transmission bursts), after the at least one SL transmission from another UE, wherein the further transmissions (or transmission bursts) are within the channel occupancy associated with the Type 1 SL channel access procedure.

In one example, if the channel is not sensed to be continuously idle after the first transmission by the UE (e.g., UE 116) or the further transmissions (or transmission bursts) are not within the channel occupancy associated with the Type 1 SL channel access procedure, the UE can perform a Type 1 channel access procedure for further SL transmissions (or transmission bursts). In another example, the another UE (e.g., UE 114) shares the channel occupancy associated with the Type 1 SL channel access procedure and performs the at least one SL transmission from the another UE. In yet another example, the at least one SL transmission from the another UE (e.g., UE 114) includes the UE (e.g., UE 116) initiating the channel occupancy as receiver (e.g., for unicast transmission) or one of the receivers (e.g., for groupcast and/or broadcast transmission). In some other examples, the UE initiating the channel occupancy may need to receive the at least one SL transmission from the another UE, before transmitting further SL transmission after the at least one SL transmission from the another UE.

FIG. 11 illustrates a diagram 1100 of continuous SL transmissions with a pause according to embodiments of this disclosure. The embodiment of the diagram 1100 illustrated in FIG. 11 is for illustration only. FIG. 11 does not limit the scope of this disclosure to any particular implementation of the diagram 1100. The contiguous SL transmission with a pause illustrated by diagram 1100 may be implemented by a UE, (e.g., UE 116), in a wireless network system (e.g., 100).

In embodiments, as illustrated in FIG. 11, when a UE (e.g., UE 116) intends to transmit a set of SL transmissions (or a set of SL transmission bursts), wherein the set of SL transmissions (or the set of SL transmission bursts) are contiguous (e.g., no time domain gap between any two neighboring transmissions or transmission bursts), and the UE (e.g., UE 116) can stop transmitting after a SL transmission (or transmission burst) and resume the transmission from the set of SL transmissions (or the set of SL transmission bursts) after a pause, at least one of the following examples can apply.

In one example, the UE (e.g., UE 116) can treat the contiguous SL transmissions with a pause as non-contiguous SL transmissions, and the example for channel access procedure in this disclosure for non-contiguous SL transmissions can apply.

In another example, the UE (e.g., UE 116) can resume the SL transmission without performing any channel access procedure, wherein the SL transmission is within the channel occupancy.

In some examples, before resuming the SL transmission, the UE (e.g., UE 116) can perform a Type 2 (e.g., Type 2A) channel access procedure. If the Type 2 channel access procedure is successful, the UE can resume the SL transmission, wherein the SL transmission is within the channel occupancy. If the Type 2 channel access procedure is not successful, the UE may not resume the transmission and may perform a Type 1 channel access procedure to initiate a channel occupancy for the remaining transmissions.

In yet other examples, after stopping the SL transmission, if the channel is continuously sensed to be idle, and before resuming the SL transmission, a Type 2 (e.g., Type 2A or Type 2B) channel access procedure is performed successfully, the UE can resume the SL transmission, wherein the SL transmission is within the channel occupancy (e.g., the CAPC of the further SL transmission is same or smaller than the CAPC of the channel occupancy). If the channel is not sensed to be continuously idle after stopping the transmission or the transmissions to be resumed are not within the channel occupancy, the UE (e.g., UE 116) can perform a Type 1 channel access procedure for further SL transmissions.

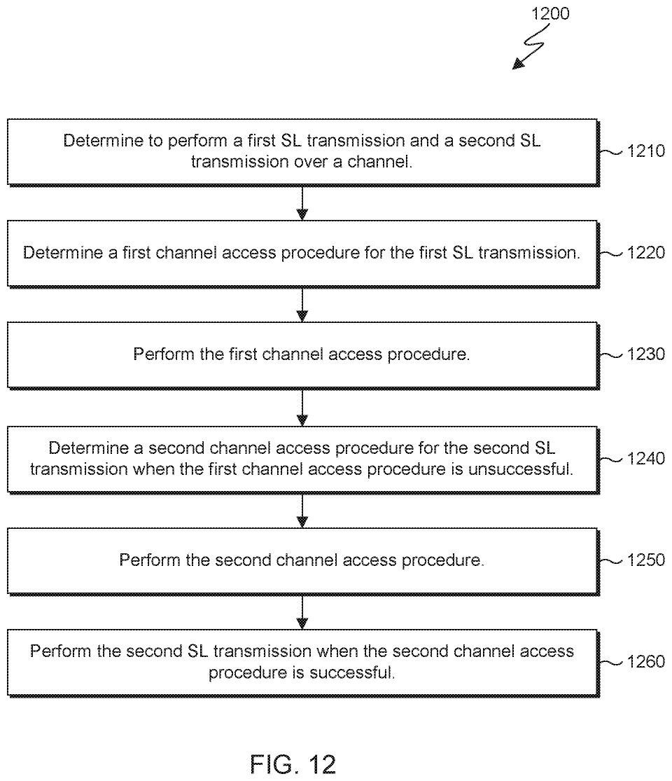

FIG. 12 illustrates a flowchart of an example UE procedure 1200 according to embodiments of the present disclosure. The UE procedure 1200 may be performed by a UE (e.g., any of the UEs 111-116 as illustrated in FIG. 1). An embodiment of the UE procedure 1200 shown in FIG. 12 is for illustration only and does not limit the scope of this disclosure to any particular implementation.

The procedure 1200 begins with the UE determining to perform a first SL transmission and a second SL transmission over a channel (1210). For example, in 1210, the first SL transmission and the second SL transmission are contiguous. The UE then determines a first channel access procedure for the first SL transmission (1220). The UE then performs the first channel access procedure (1230). The UE then determines a second channel access procedure for the second SL transmission when the first channel access procedure is unsuccessful (1240). The UE then performs the second channel access procedure (1250).

In various embodiments, the first channel access procedure is a first Type 1 SL channel access procedure, and the second channel access procedure is a second Type 1 SL channel access procedure. In these embodiments, a time duration spanned by sensing slots that are sensed to be idle before a SL transmission using the first and second Type 1 SL channel access procedures is based on a random counter.

In various embodiments, the first channel access procedure is a first Type 2A or a Type 2B SL channel access procedure and the second channel access procedure is a second Type 2A SL channel access procedure. In these embodiments, a time duration spanned by sensing slots that are sensed to be idle before a SL transmission using the first and second Type 2A SL channel access procedures is deterministic as 25 μs and a time duration spanned by sensing slots that are sensed to be idle before a SL transmission using the Type 2B SL channel access procedure is deterministic as 16 μs.

The UE then performs the second SL transmission when the second channel access procedure is successful (1260).

In various embodiments, the UE further performs a third channel access procedure to initiate a channel occupancy and performs a third SL transmission when the third channel access procedure is successful. The UE may then determine to perform a fourth SL transmission, where the fourth SL transmission and the third SL transmission are non-continuous and have a gap there between. The UE may then sense the channel to be continuously idle in the gap and perform a Type 2A SL channel access procedure before the fourth SL transmission. Here, a time duration spanned by sensing slots that are sensed to be idle before a SL transmission using the Type 2A SL channel access procedure is deterministic as 25 μs. The UE may then perform the fourth SL transmission when the Type 2A SL channel access procedure successful.

In various embodiments, the UE further determines to transmit a PSSCH or a PSCCH over the channel and determines two starting symbols in a slot for transmission of the PSSCH or PSCCH. The UE may then perform a third channel access procedure before a first starting symbol in the slot, which is not successful, and perform a fourth channel access procedure before a second starting symbol in the slot. The UE may then transmit the PSSCH or PSCCH from the second starting symbol in the slot when the fourth channel access procedure is successful. In some examples, the third channel access procedure is a first Type 1 SL channel access procedure, the fourth channel access procedure is a second Type 1 SL channel access procedure, there is no limit on a number of attempts to perform the second Type 1 SL channel access procedure and a time duration spanned by sensing slots that are sensed to be idle before a SL transmission using the first and second Type 1 SL channel access procedures is based on a random counter. In some examples, the third channel access procedure is a first Type 2A or a Type 2B SL channel access procedure, the fourth channel access procedure is a second Type 2A SL channel access procedure, a time duration spanned by sensing slots that are sensed to be idle before a SL transmission using the first and second Type 2A SL channel access procedures is deterministic as 25 μs, and a time duration spanned by sensing slots that are sensed to be idle before a SL transmission using the Type 2B SL channel access procedure is deterministic as 16 μs. In some examples, the second starting symbol in the slot is used for the transmission of the PSSCH or PSCCH when the third channel access procedure before the first starting symbol is not successful.

In various embodiments, the UE may further determine a SL transmission burst as a set of SL transmissions from the UE, wherein a gap between SL transmissions in the set is no larger than 16 μs and determine not to perform sensing over the channel within the gap.

In various embodiments, the UE may perform a Type 1 SL channel access procedure before a third SL transmission, where a time duration spanned by sensing slots that are sensed to be idle before the third SL transmission using the Type 1 SL channel access procedure is based on a random counter, and determine not to perform the third SL transmission on a first time t₁ when a value of the random counter is 0. The UE may then determine to perform the third SL transmission on a second time t₂, where t₂>t₁; perform a first sensing of the channel before t₂, where a first duration of the first sensing is Tₛₗ=9 μs; and perform a second sensing of the channel before t₂, where a second duration of the first sensing is T_{d}=T_{f}+mₚ·Tₛₗ, T_{f}=16 μs and mₚ is determined based on a channel access priority class associated with the Type 1 SL channel access procedure. The UE may then perform the third SL transmission from t₂ when the channel being sensed as idle in the first and second sensings.

Any of the above variation embodiments can be utilized independently or in combination with at least one other variation embodiment. The above flowchart illustrates example methods that can be implemented in accordance with the principles of the present disclosure and various changes could be made to the methods illustrated in the flowchart herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a processor configured to:
determine to perform a first sidelink (SL) transmission and a second SL transmission over a channel, wherein the first SL transmission and the second SL transmission are contiguous;
determine a first channel access procedure for the first SL transmission;
perform the first channel access procedure;
determine a second channel access procedure for the second SL transmission when the first channel access procedure is unsuccessful; and
perform the second channel access procedure;
a transceiver operably coupled to the processor, the transceiver configured to perform the second SL transmission when the second channel access procedure is successful.

2. The UE of claim 1, wherein:
the first channel access procedure is a first Type 1 SL channel access procedure;
the second channel access procedure is a second Type 1 SL channel access procedure; and
a time duration spanned by sensing slots that are sensed to be idle before a SL transmission using the first and second Type 1 SL channel access procedures is based on a random counter.

3. The UE of claim 1, wherein:
the first channel access procedure is a first Type 2A or a Type 2B SL channel access procedure;
the second channel access procedure is a second Type 2A SL channel access procedure;
a time duration spanned by sensing slots that are sensed to be idle before a SL transmission using the first and second Type 2A SL channel access procedures is deterministic as 25 microseconds (μs); and
a time duration spanned by sensing slots that are sensed to be idle before a SL transmission using the Type 2B SL channel access procedure is deterministic as 16 μs.

4. The UE of claim 1, wherein:
the processor is further configured to perform a third channel access procedure to initiate a channel occupancy;
the transceiver is further configured to perform a third SL transmission when the third channel access procedure is successful;
the processor is further configured to:
determine to perform a fourth SL transmission, wherein the fourth SL transmission and the third SL transmission are non-continuous and have a gap there between;
sense the channel to be continuously idle in the gap;
perform a Type 2A SL channel access procedure before the fourth SL transmission, wherein a time duration spanned by sensing slots that are sensed to be idle before a SL transmission using the Type 2A SL channel access procedure is deterministic as 25 microseconds (μs); and
the transceiver is further configured to perform the fourth SL transmission when the Type 2A SL channel access procedure successful.

5. The UE of claim 1, wherein:
the processor is further configured to:
determine to transmit a physical sidelink shared channel (PSSCH) or a physical sidelink control channel (PSCCH) over the channel;
determine two starting symbols in a slot for transmission of the PSSCH or PSCCH;
perform a third channel access procedure before a first starting symbol in the slot, wherein the third channel access procedure is not successful; and
perform a fourth channel access procedure before a second starting symbol in the slot; and
the transceiver is further configured to transmit the PSSCH or PSCCH from the second starting symbol in the slot when the fourth channel access procedure is successful.

6. The UE of claim 5, wherein:
the third channel access procedure is a first Type 1 SL channel access procedure;
the fourth channel access procedure is a second Type 1 SL channel access procedure;
there is no limit on a number of attempts to perform the second Type 1 SL channel access procedure; and
a time duration spanned by sensing slots that are sensed to be idle before a SL transmission using the first and second Type 1 SL channel access procedures is based on a random counter.

7. The UE of claim 5, wherein:
the third channel access procedure is a first Type 2A or a Type 2B SL channel access procedure;
the fourth channel access procedure is a second Type 2A SL channel access procedure;
a time duration spanned by sensing slots that are sensed to be idle before a SL transmission using the first and second Type 2A SL channel access procedures is deterministic as 25 microseconds (μs); and
a time duration spanned by sensing slots that are sensed to be idle before a SL transmission using the Type 2B SL channel access procedure is deterministic as 16 μs.

8. The UE of claim 5, wherein the second starting symbol in the slot is used for the transmission of the PSSCH or PSCCH when the third channel access procedure before the first starting symbol is not successful.

9. The UE of claim 1, wherein the processor is further configured to:
determine a SL transmission burst as a set of SL transmissions from the UE, wherein a gap between SL transmissions in the set is no larger than 16 microseconds (μs); and
determine not to perform sensing over the channel within the gap.

10. The UE of claim 1, wherein:
the processor is further configured to:
perform a Type 1 SL channel access procedure before a third SL transmission, wherein a time duration spanned by sensing slots that are sensed to be idle before the third SL transmission using the Type 1 SL channel access procedure is based on a random counter;
determine not to perform the third SL transmission on a first time t₁ when a value of the random counter is 0;
determine to perform the third SL transmission on a second time t₂, where t₂>t₁;
perform a first sensing of the channel before t₂, where a first duration of the first sensing is Tₛₗ=9 microseconds (μs); and
perform a second sensing of the channel before t₂, where a second duration of the first sensing is T_{d}=T_{f}+mₚ·Tₛₗ, T_{f}=16 μs and mₚ is determined based on a channel access priority class associated with the Type 1 SL channel access procedure; and
the transceiver is further configured to perform the third SL transmission from t₂ when the channel being sensed as idle in the first and second sensings.

11. A method of a user equipment (UE) in a wireless communication system, the method comprising:
determining to perform a first sidelink (SL) transmission and a second SL transmission over a channel, wherein the first SL transmission and the second SL transmission are contiguous;
determining a first channel access procedure for the first SL transmission;
performing the first channel access procedure;
determining a second channel access procedure for the second SL transmission when the first channel access procedure is unsuccessful;
performing the second channel access procedure; and
performing the second SL transmission when the second channel access procedure is successful.

12. The method of claim 11, wherein:
the first channel access procedure is a first Type 1 SL channel access procedure;
the second channel access procedure is a second Type 1 SL channel access procedure; and
a time duration spanned by sensing slots that are sensed to be idle before a SL transmission using the first and second Type 1 SL channel access procedures is based on a random counter.

13. The method of claim 11, wherein:
the first channel access procedure is a first Type 2A or a Type 2B SL channel access procedure;
the second channel access procedure is a second Type 2A SL channel access procedure;
a time duration spanned by sensing slots that are sensed to be idle before a SL transmission using the first and second Type 2A SL channel access procedures is deterministic as 25 microseconds (μs); and
a time duration spanned by sensing slots that are sensed to be idle before a SL transmission using the Type 2B SL channel access procedure is deterministic as 16 μs.

14. The method of claim 11, further comprising:
performing a third channel access procedure to initiate a channel occupancy;
performing a third SL transmission when the third channel access procedure is successful;
determining to perform a fourth SL transmission, wherein the fourth SL transmission and the third SL transmission are non-continuous and have a gap there between;
sensing the channel to be continuously idle in the gap;
performing a Type 2A SL channel access procedure before the fourth SL transmission, wherein a time duration spanned by sensing slots that are sensed to be idle before a SL transmission using the Type 2A SL channel access procedure is deterministic as 25 microseconds (μs); and
performing the fourth SL transmission when the Type 2A SL channel access procedure successful.

15. The method of claim 11, further comprising:
determining to transmit a physical sidelink shared channel (PSSCH) or a physical sidelink control channel (PSCCH) over the channel;
determining two starting symbols in a slot for transmission of the PSSCH or PSCCH;
performing a third channel access procedure before a first starting symbol in the slot, wherein the third channel access procedure is not successful;
performing a fourth channel access procedure before a second starting symbol in the slot; and
transmitting the PSSCH or PSCCH from the second starting symbol in the slot when the fourth channel access procedure is successful.

16. The method of claim 15, wherein:
the third channel access procedure is a first Type 1 SL channel access procedure;
the fourth channel access procedure is a second Type 1 SL channel access procedure;
there is no limit on a number of attempts to perform the second Type 1 SL channel access procedure; and
a time duration spanned by sensing slots that are sensed to be idle before a SL transmission using the first and second Type 1 SL channel access procedures is based on a random counter.

17. The method of claim 15, wherein:
the third channel access procedure is a first Type 2A or a Type 2B SL channel access procedure;
the fourth channel access procedure is a second Type 2A SL channel access procedure;
a time duration spanned by sensing slots that are sensed to be idle before a SL transmission using the first and second Type 2A SL channel access procedures is deterministic as 25 microseconds (μs); and
a time duration spanned by sensing slots that are sensed to be idle before a SL transmission using the Type 2B SL channel access procedure is deterministic as 16 μs.

18. The method of claim 15, wherein the second starting symbol in the slot is used for the transmission of the PSSCH or PSCCH when the third channel access procedure before the first starting symbol is not successful.

19. The method of claim 11, further comprising:
determining a SL transmission burst as a set of SL transmissions from the UE, wherein a gap between SL transmissions in the set is no larger than 16 microseconds (μs); and
determining not to perform sensing over the channel within the gap.

20. A method of claim 11, further comprising:
performing a Type 1 SL channel access procedure before a third SL transmission, wherein a time duration spanned by sensing slots that are sensed to be idle before the third SL transmission using the Type 1 SL channel access procedure is based on a random counter;
determining not to perform the third SL transmission on a first time t₁ when a value of the random counter is 0;
determining to perform the third SL transmission on a second time t₂, where t₂>t₁;
performing a first sensing of the channel before t₂, where a first duration of the first sensing is Tₛₗ=9 microseconds (μs);
performing a second sensing of the channel before t₂, where a second duration of the first sensing is T_{d}=T_{f}+mₚ·Tₛₗ, T_{f}=16 μs and mₚ is determined based on a channel access priority class associated with the Type 1 SL channel access procedure; and
performing the third SL transmission from t₂ when the channel being sensed as idle in the first and second sensings.
